(19) United States
(12) Patent Application Publication
(10) Pub. No.: US 2006/0290632 A1
(43) Pub. Date: Dec. 28, 2006

(54) DISPLAY AND ARRAY SUBSTRATE

(76) Inventor: Makoto SHIBUSAWA, Fukaya-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/425,575

(22) Filed: Jun. 21, 2006

(30) Foreign Application Priority Data
Jun. 23, 2005 (JP) 2005-183386

(51) Int. Cl. G09G 3/36

(52) U.S. Cl. 345/92

(57) ABSTRACT

A display includes pixels arranged in a matrix. Each pixel includes a drive transistor whose source or drain being connected to a power supply terminal, a display element including a pixel electrode, a counter electrode connected to a second power supply terminal, and an active layer interposed therebetween, and a switching transistor. The drive transistor and the switching transistor are connected in series between the power supply terminal and the pixel electrode in this order. In each pixel, a semiconductor layer in which the source and drain of the drive transistor are formed and a semiconductor layer in which source and drain of the first switching transistor are formed are joined together.

### CROSS-REFERENCE TO RELATED APPLICATIONS

This application is based upon and claims the benefit of priority from prior Japanese Patent Application No. 2005-183386, filed Jun. 23, 2005, the entire contents of which are incorporated herein by reference.

### BACKGROUND OF THE INVENTION

1. Field of the Invention

The present invention relates to a display and an array substrate, and particularly, to an active matrix display and an array substrate used therein.

2. Description of the Related Art

When an image is to be displayed on an active matrix organic electroluminescent (herein after to be referred to as “EL”) display, pixels are selected, for example, on a line-by-line basis. During a selection period over which a pixel is selected, a video signal is written on the pixel. During a non-selection period over which a pixel is not selected, the pixel allows a drive current to flow through its organic EL element at magnitude corresponding to the magnitude of the video signal. The organic EL element emits light at luminance corresponding to the magnitude of the drive current. Thus, in the active matrix organic EL display, a gray level to be displayed on each pixel is controlled by the magnitude of the video signal.

In the active matrix organic EL display, a current signal or voltage signal can be used as the video signal.

U.S. Pat. No. 6,373,454 describes an active matrix organic EL display that utilizes a current signal as the video signal. Each pixel of the display includes an n-channel field-effect transistor as a drive transistor, an organic EL element, a capacitor, and first to third switching transistors. The drive transistor, the first switching transistor, and the organic EL element are connected in series between a low-potential power supply line and a high-potential power supply line in this order. The capacitor is connected between the low-potential power supply line and the gate of the drive transistor. The second switching transistor is connected between the drain and gate of the drive transistor. The third switching transistor is connected between the drain of the drive transistor and a video signal line.

U.S. Pat. No. 6,229,506 describes an active matrix organic EL display that utilizes a voltage signal as the video signal. Each pixel of the display includes a p-channel field-effect transistor as a drive transistor, an organic EL element, first and second capacitors, and first to third switching transistors. The drive transistor, the first switching transistor, and the organic EL element are connected in series between a high-potential power supply line and a low-potential power supply line in this order. The first capacitor is connected between the high-potential power supply line and the gate of the drive transistor. The second switching transistor is connected between the drain and gate of the drive transistor. An electrode of the second capacitor is connected to the gate of the drive transistor. The switching transistor is connected between a video signal line and another electrode of the second capacitor.

In the organic EL display described in U.S. Pat. No. 6,229,506, even if the pixels vary in threshold voltage and mobility of the drive transistor, the variation would not cause the variation in magnitudes of drive currents allowed to flow through the organic EL elements. Likewise, in the organic EL display described in U.S. Pat. No. 6,229,506, even if the pixels vary in threshold voltage of the drive transistor, the variation would not cause the variation in magnitudes of drive currents allowed to flow through the organic EL elements. Therefore, the organic EL displays are expected to achieve excellent evenness in brightness.

However, the present inventor has found in achieving the present invention that the organic EL displays may not achieve sufficient evenness in brightness.

### BRIEF SUMMARY OF THE INVENTION

According to a first aspect of the present invention, there is provided a display comprising pixels arranged in a matrix, each of the pixels comprising a drive transistor whose source or drain being connected to a first power supply terminal, a display element comprising a pixel electrode, a counter electrode connected to a second power supply terminal, and an active layer interposed therebetween, and a first switching transistor, the drive transistor and the first switching transistor being connected in series between the first power supply terminal and the pixel electrode in this order, wherein, in each of the pixels, a semiconductor layer in which the source and drain of the drive transistor are formed and a semiconductor layer in which source and drain of the first switching transistor are formed are joined together.

According to a second aspect of the present invention, there is provided a display comprising pixels arranged in a matrix, video signal lines arranged correspondently with columns of the pixels, first scan signal lines arranged correspondently with rows of the pixels, and second scan signal lines arranged correspondently with the rows of the pixels, each of the pixels comprising a drive transistor whose source or drain is connected to a first power supply terminal, a display element comprising a pixel electrode, a counter electrode connected to a second power supply terminal, and an active layer interposed therebetween, a first switching transistor whose gate is connected to the first scan signal line, the drive transistor and the first switching transistor being connected in series between the first power supply terminal and the pixel electrode in this order, a second switching transistor which is connected between the drain and gate of the drive transistor and whose gate is connected to the second scan signal line, a third switching transistor comprising an input terminal connected to the video signal line, and a first capacitor connected between the gate of the drive transistor and a constant-potential terminal, wherein, in each of the pixels, the first capacitor is located at a position between the first scan signal line to which the gate of the first switching transistor included in the pixel is connected and the second scan signal line to which the gate of the second switching transistor included in the pixel is connected.

According to a third aspect of the present invention, there is provided an array substrate comprising pixel circuits arranged in a matrix, each of the pixel circuits comprising a drive transistor whose source or drain being connected to a power supply terminal, a pixel electrode, and a first switching transistor, the drive transistor and the first switching transistor being connected in series between the power supply terminal and the pixel electrode in this order, wherein, in each of the pixel circuits, a semiconductor layer in which the source and drain of the drive transistor are formed and a semiconductor layer in which source and drain of the first switching transistor are formed are joined together.

According to a fourth aspect of the present invention, there is provided an array substrate comprising pixel circuits arranged in a matrix, video signal lines arranged correspondently with columns of the pixel circuits, first scan signal lines arranged correspondently with rows of the pixel circuits, and second scan signal lines arranged correspondently with the rows of the pixel circuits, each of the pixel circuits comprising a drive transistor whose source or drain is connected to a power supply terminal, a pixel electrode, a first switching transistor whose gate is connected to the first scan signal line, the drive transistor and the first switching transistor being connected in series between the power supply terminal and the pixel electrode in this order, a second switching transistor which is connected between the drain and gate of the drive transistor and whose gate is connected to the second scan signal line, a third switching transistor comprising an input terminal connected to the video signal line, and a first capacitor connected between the gate of the drive transistor and a constant-potential terminal, wherein, in each of the pixel circuits, the first capacitor is located at a position between the first scan signal line to which the gate of the first switching transistor included in the pixel circuit is connected and the second scan signal line to which the gate of the second switching transistor included in the pixel circuit is connected.

### BRIEF DESCRIPTION OF THE SEVERAL VIEWS OF THE DRAWING

FIG. 1 is a plan view schematically showing the display according to the first embodiment of the present invention;

FIG. 2 is a sectional view schematically showing an example of the structure that can be employed in the display shown in FIG. 1;

FIG. 3 is a plan view schematically showing an example of the configuration that can be employed in a pixel included in the display shown in FIG. 1;

FIG. 4 is a plan view schematically showing a pixel of the display according to a comparative example;

FIG. 5 is a plan view schematically showing a display according to the second embodiment of the present invention;

FIG. 6 is a plan view schematically showing an example of the configuration that can be employed in a pixel included in the display shown in FIG. 6; and

FIG. 7 is a plan view schematically showing a pixel of the display according to another comparative example.

### DETAILED DESCRIPTION OF THE INVENTION

Embodiments of the present invention will be described below in detail with reference to the drawings. In the drawings, components having the same or similar function are denoted by the same reference symbol and duplicate descriptions will be omitted.

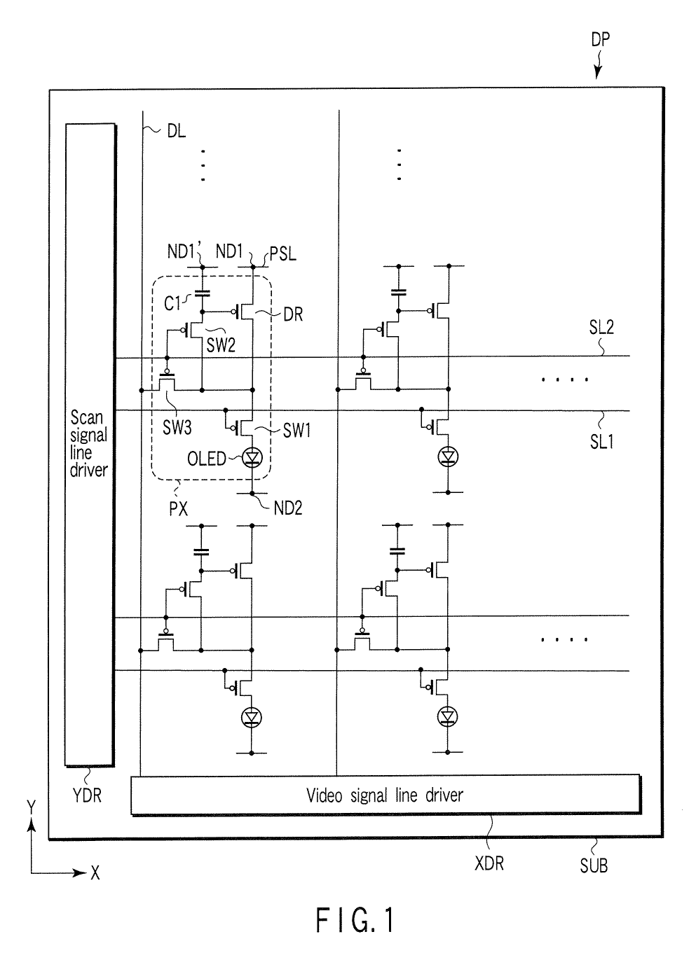

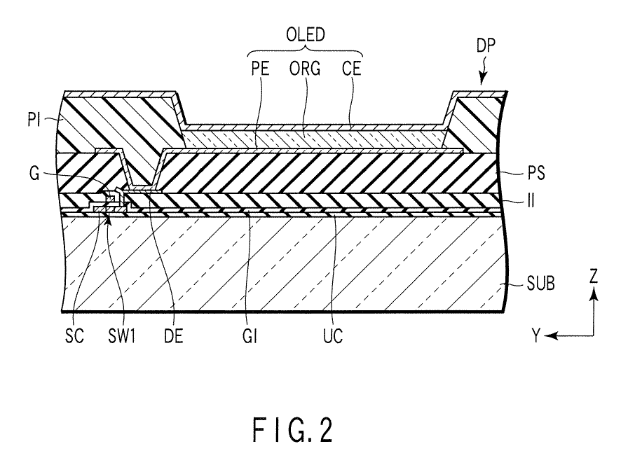

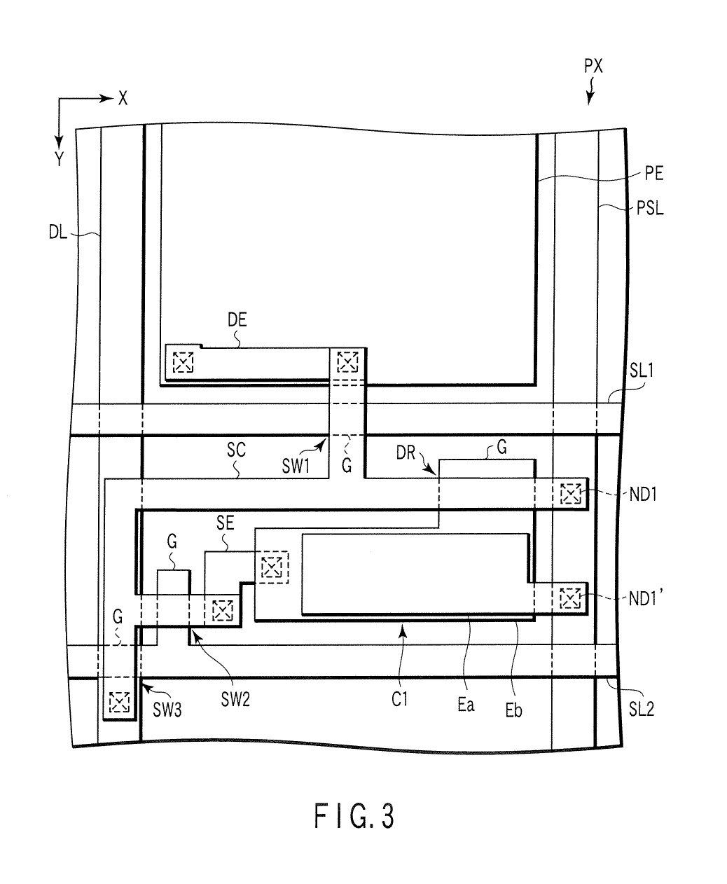

FIG. 1 is a plan view schematically showing the display according to the first embodiment of the present invention. FIG. 2 is a sectional view schematically showing an example of the structure that can be employed in the display shown in FIG. 1. FIG. 3 is a plan view schematically showing an example of the configuration that can be employed in a pixel included in the display shown in FIG. 1.

In FIG. 2, the display is drawn such that its display surface, i.e., the front surface or light-emitting surface, faces downwardly and its back surface faces upwardly. In FIG. 3, the configuration of the pixel when viewed from the display surface's side is drawn.

The display is a bottom emission organic EL display that employs an active matrix driving method. As shown in FIG. 1, the organic EL display includes a display panel DP, a video signal line driver XDR, and a scan signal line driver YDR.

As shown in FIGS. 1 and 2, the display panel DP includes an insulating substrate SUB such as glass substrate.

On the substrate SUB, an undercoat layer UC is formed as shown in FIG. 2. For example, the undercoat layer UC is formed by sequentially stacking an SiNₓ layer and an SiOₓ layer on the substrate SUB.

On the undercoat layer UC, the semiconductor layers SC shown in FIGS. 2 and 3 are arranged correspondingly with the pixels PX that will be described later. Each semiconductor SC is, for example, a polysilicon layer that includes a p-type region and an n-type region. In this embodiment, of the semiconductor layer SC, the region facing the member denoted by the reference symbol G is an intrinsic region, and the other regions are p⁺-type regions.

On the undercoat layer UC, the electrodes Ea shown in FIG. 3 are further arranged correspondingly with the pixels PX. The electrodes Ea are, for example, n⁺-type polysilicon layers.

The semiconductor layers SC and the electrodes Ea are covered with the gate insulator GI shown in FIG. 2. The gate insulator GI can be formed, for example, by using tetraethyl orthosilicate (TEOS).

On the gate insulator GI, the scan signal lines SL1 and SL2 shown in FIGS. 1 and 3 are arranged. As shown in FIG. 1, the scan signal lines SL1 and SL2 extend in a direction (X direction) along rows of the pixels PX and are alternately arranged in a direction (Y direction) along columns of the pixels PX. For example, the scan signal lines SL1 and SL2 are made of MoW.

On the gate insulator GI, the electrodes Eb shown in FIG. 3 are further arranged. The electrodes Eb are arranged correspondingly with the pixels PX. Each electrode Eb is located at a position between the scan signal lines SL1 and SL2 that intersect the same semiconductor layer SC. The electrodes Eb are made of MoW, for example. The electrodes Eb can be formed in the same step as that for the scan signal lines SL1 and SL2.

As shown in FIG. 3, in each pixel PX, the scan signal line SL1 and the semiconductor layer SC intersect at a single point, and the scan signal line SL2 and the semiconductor layer SC intersect at two points. Further, as shown in FIG. 3, in each pixel PX, the electrode Eb faces the electrode Ea and intersects the semiconductor layer SC at a single point.

The intersection portion of the scan signal line SL1 and the semiconductor layer SC forms the first switching transistor SW1 shown in FIGS. 1 to 3, and the intersection portions of the scan signal line SL2 and the semiconductor layer form the second switching transistor SW2 and the third switching transistor SW3 shown in FIG. 3. Further, the electrodes Ea and Eb and the part of the insulating film GI interposed therebetween form the capacitor C1 shown in FIGS. 1 and 3, and the intersection portion of the electrode Eb and the semiconductor layer SC forms the drive transistor DR shown in FIGS. 1 and 3.

Note that in this embodiment, the drive transistor DR and the switching transistors SW1 to SW3 are top-gate type p-channel thin-film transistors, and the parts of the scan signal lines SL1 and SL2 and the electrode Eb denoted by the reference symbols G are gates of the thin-film transistors.

The gate insulator GI, the scan signal lines SL1 and SL2, and the electrodes Eb are covered with the interlayer insulating film II shown in FIG. 2. For example, the interlayer insulating film II is an SiOₓ layer formed by plasma chemical vapor deposition (CVD).

On the interlayer insulating film II, the video signal lines DL and power supply lines PSL shown in FIGS. 1 and 3 are formed. The video signal lines DL extend in the Y direction and are arranged in the X direction. The power supply lines PSL extend in the Y direction and are arranged in the X direction in this embodiment.

On the interlayer insulating film II, the source electrodes shown in FIG. 3 and the drain electrodes shown in FIGS. 2 and 3 are further formed. In this embodiment, each pixel PX includes one source electrode SE and one drain electrode DE.

The source electrodes are connected to the sources of the switching transistors SW2 via contact holes formed in the interlayer insulating film II and the gate insulator GI, and are connected to the electrodes Eb via contact holes formed in the interlayer insulating film II. The drain electrodes DE are connected to the drains of the switching transistors SW1 via contact holes formed in the interlayer insulating film II and the gate insulator GI.

For example, the video signal lines DL, the power supply lines PSL, source electrodes SE, and drain electrodes DE have a three-layer structure. These components can be formed in the same step.

The video signal lines DL, the power supply lines PSL, the source electrodes SE, and the drain electrodes DE are covered with the passivation layer PS shown in FIG. 2. The passivation layer PS is made of SiNₓ, for example.

On the passivation layer PS, the pixel electrodes PE shown in FIGS. 2 and 3 are arranged correspondingly with the pixels PX. Each pixel electrode PE is connected to the drain electrode DE via a contact hole formed in the passivation layer PS.

In this embodiment, the pixel electrodes PE are light-transmissible front electrodes. Also, in this embodiment, the pixel electrodes PE are anodes. As material of the pixel electrodes PE, for example, transparent conductive oxides such as indium tin oxide (ITO) can be used.

On the passivation layer PS, the partition insulating layer PI shown in FIG. 2 is further formed. The partition insulating layer PI is provided with through-holes at positions corresponding to the pixel electrodes PE. Alternatively, the partition insulating layer PI is provided with slits at positions corresponding to columns or rows of the pixel electrodes PE. As an example, it is supposed that through-holes are formed in the partition insulating layer PI at positions corresponding to the pixel electrodes PE.

The partition insulating layer PI is, for example, an organic insulating layer. The partition insulating layer PI can be formed by using photolithography technique, for example.

On the pixel electrodes PE, organic layers ORG including emitting layers are formed as active layers. The emitting layers are, for example, thin film containing a luminescent organic compound that emits red, green, or blue light. In addition to the emitting layer, each organic layer ORG may include a hole injection layer, a hole transporting layer, a hole blocking layer, an electron transporting layer, and an electron injection layer.

The partition insulating layer PI and the organic layers ORG are covered with a counter electrode CE. In this embodiment, the counter electrode CE is a common electrode shared among the pixels PX. Also, in this embodiment, the counter electrode CE is a light-reflective cathode serving as a back electrode. For example, an electrode wire (not shown) is formed on the layer on which the video signal lines DL are formed, and the counter electrode CE is electrically connected to the electrode wire via a contact hole formed in the passivation layer PS and partition insulating layer PI. Each organic EL element OLED is composed of the pixel electrode PE, organic layer ORG, and counter electrode CE.

As shown in FIG. 1, each pixel PX includes the drive transistor DR, the switching transistors SW1 to SW3, the organic EL element OLED, and the capacitor C1. As described above, in this embodiment, the drive transistor DR and the switching transistors SW1 to SW3 are p-channel thin-film transistor.

The drive transistor DR, the switching transistor SW1, and the organic EL element OLED are connected in series between the first power supply terminal ND1 and the second power supply terminal ND2 in this order. In this embodiment, the power supply terminal ND1 is a high-potential power supply terminal, and the power supply terminal ND2 is a low-potential power supply terminal.

The gate of the switching transistor SW1 is connected to the scan signal line SL1. The switching transistor SW2 is connected between the drain and gate of the drive transistor DR, and its gate is connected to the scan signal line SL2. The switching transistor SW3 is connected between the video signal line DL and the drain of the drive transistor DR, and its gate is connected to the scan signal line SL2.

The capacitor C1 is connected between the gate of the drive transistor DR and the constant-potential terminal ND1′. In this embodiment, the constant-potential terminal ND1′ is connected to the power supply terminal ND1.

Note that the structure of the display panel DP from which the counter electrode CE and the organic layers ORG are omitted corresponds to an array substrate. Note also that the structure of the pixel PX from which the counter electrode CE and the organic layer ORG are omitted corresponds to a pixel circuit.

The video signal line driver XDR and the scan signal line driver YDR are connected to the display panel DP in the chip-on-glass (COG) manner. Instead, the video signal line driver XDR and the scan signal line driver YDR may be connected to the display panel DP by using the tape carrier package (TCP).

Video signal lines DL are connected to the video signal line driver XDR. In this embodiment, the power supply lines PSL are further connected to the video signal line driver XDR. The video signal line driver XDR outputs current signals as video signals to the video signal lines DL, and outputs a supply voltage to the power supply lines PSL.

The scan signal lines SL1 and SL2 are connected to the scan signal line driver YDR. The scan signal line driver YDR outputs voltage signals as first and second scan signals to the scan signal lines SL1 and SL2, respectively.

When an image is to be displayed on the organic EL display, the scan signal lines SL2 are sequentially energized. That is, the pixels PX are scanned or selected on a line-by-line basis. A write operation is executed on a pixel PX during its selection period, and a display operation is executed on a pixel PX during its non-selection period.

During the selection period over which a pixel PX is selected, the scan signal line driver YDR outputs a scan signal for opening the switching transistor SW1, i.e., a scan signal for bringing switching transistor SW1 to a non-conducting state as a voltage signal to the scan signal line SL1 to which the pixel PX is connected. Subsequently, the scan signal line driver YDR outputs a scan signal for closing the switching transistors SW2 and SW3, i.e., a scan signal for bringing the switching transistors SW2 and SW3 to a conducting state as a voltage signal to the scan signal line SL2 to which the pixel PX is connected. In this state, the video signal line driver XDR outputs a video signal as a current signal (write current) to the video signal line DL to which the pixel PX is connected, so as to set the gate-to-source voltage V_{gs} of the drive transistor DR at a value corresponding to the magnitude of the video signal I_{sig}. Then, the scan signal line driver YDR outputs a scan signal for opening the switching transistors SW2 and SW3 as a voltage signal to the scan signal line SL2 to which the pixel PX is connected. Subsequently, the scan signal line driver YDR outputs a scan signal for closing the switching transistor SW1 as a voltage signal to the scan signal line SL1 to which the pixel PX is connected. This terminates the selection period.

During the non-selection period, the switching transistor SW1 is kept closed, and the switching transistors SW2 and SW3 are kept open. In the non-selection period, a drive current I_{drv} flows through the organic EL element OLED at magnitude corresponding to the gate-to-source voltage V_{gs} of the drive transistor DR. The organic EL element OLED emits light at luminance corresponding to the magnitude of the drive current I_{drv}.

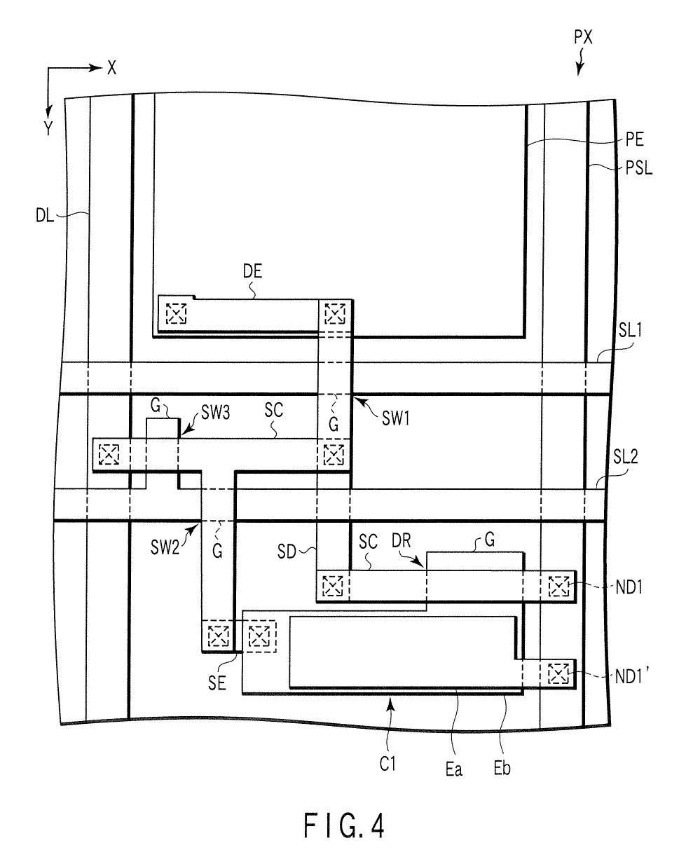

Since the configuration shown in FIG. 3 is employed in the pixel PX, the display is excellent in grayscale reproducibility. This is described with reference to FIGS. 3 and 4.

FIG. 4 is a plan view schematically showing a pixel of the display according to a comparative example. The display according to the comparative example has a structure similar to that of the display described with reference to FIGS. 1 to 3 except for the following.

As shown in FIG. 4, in the display according to the comparative example, each pixel PX includes not one semiconductor layer SC but two semiconductor layers SC. In each pixel PX, one of the semiconductor layers SC intersects the scan signal line SL1 at a single point and intersects the scan signal line SL2 at two points. Also, in each pixel PX, the other of the semiconductor layers SC intersects the electrode Eb at a single point. The intersection portion of the scan signal line SL1 and the semiconductor layer SC forms the switching transistor SW1, and the intersection portions of the scan signal line SL2 and the semiconductor layer SC form the switching transistors SW2 and SW3. Further, the intersection portion of the electrode Eb and the semiconductor layer SC forms the drive transistor DR.

Each electrode Eb is not located at a position between the scan signal lines SL1 and SL2 that intersect the same semiconductor layer SC. Each electrode Eb is located at a position between the scan signal line SL1 that is connected to a pixel PX and the scan signal line SL2 that is connected to another pixel PX adjacent to the above pixel PX in the Y direction.

Each pixel includes one electrode SD that serves as the source electrode and the drain electrode in addition to one source electrode SE and one drain electrode DE. The electrode SD is made of the same material as that of the source electrode SE and the drain electrode DE. The electrode SD connects two semiconductor layers SC included in the pixel PX together. Specifically, the electrode SD is connected between the drain of the drive transistor DR and the source of the switching transistor SW1.

As described above, in the pixel PX shown in FIG. 4, the electrode Eb is located at a position between the scan signal line SL1 that is connected to a pixel PX and the scan signal line SL2 that is connected to another pixel PX adjacent to the above pixel PX in the Y direction. Thus, the conductive path connecting the drain of the drive transistor DR to the source of the switching transistor SW1 must intersect the scan signal line SL2.

The write current flows the conductive path in the selection period, and the drive current flows through the conductive path in the non-selection period. That is, the conductive path is used in both of the selection period and the non-selection period. Thus, the conductivity of the conductive path should be constant in the selection period and the non-selection period. Further, in view of decreasing the wiring capacity, it is advantageous to place the conductive layer far from the scan signal line SL2. For this reason, in the pixel shown in FIG. 4, not the semiconductor layer SC but the electrode SD is used as the conductive layer.

In general, since the contact holes in the gate insulator GI and the interlayer insulating film II are formed by etching, relatively large variations occur in the contact resistance between the electrode SD and the semiconductor layer SC. The contact resistance affects a difference between the magnitude of the write current flowing through the drive transistor DR in the selection period and the magnitude of the drive current flowing through the drive transistor DR in the non-selection period. Thus, if the write currents with the same magnitude were written on the pixels PX, the drive currents would vary in magnitude among the pixels PX. Therefore, when the configuration shown in FIG. 4 is employed in each pixel PX, it is difficult to display an image with sufficient evenness in brightness.

In contrast, the pixel PX shown in FIG. 3 does not included the electrode SD. Therefore, the display shown in FIGS. 1 and 2 whose pixels PX employ the configuration shown in FIG. 3 never causes insufficient evenness in brightness due to the contact resistance between the electrode SD and the semiconductor layer SC. That is, according to the present embodiment, it is possible to prevent occurrence of insufficient evenness in brightness.

The configuration shown in FIG. 3 does not include the electrode SD shown in FIG. 4. In addition, the configuration shown in FIG. 3 is smaller in number of the contact holes than the configuration shown in FIG. 4. Since the area ratio of the electrode SD and the contact holes with respect to the pixel PX is relatively large, the configuration shown in FIG. 3 is advantageous in achieving high definition and high aperture ratio as compared to the configuration shown in FIG. 4.

The second embodiment of the present invention will be described below.

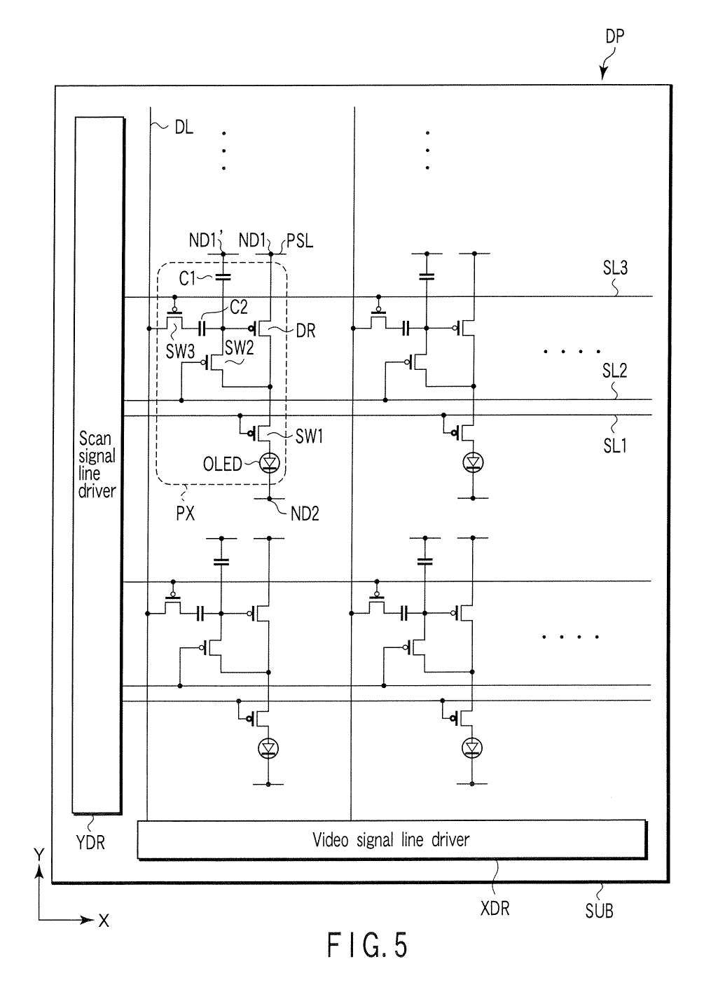

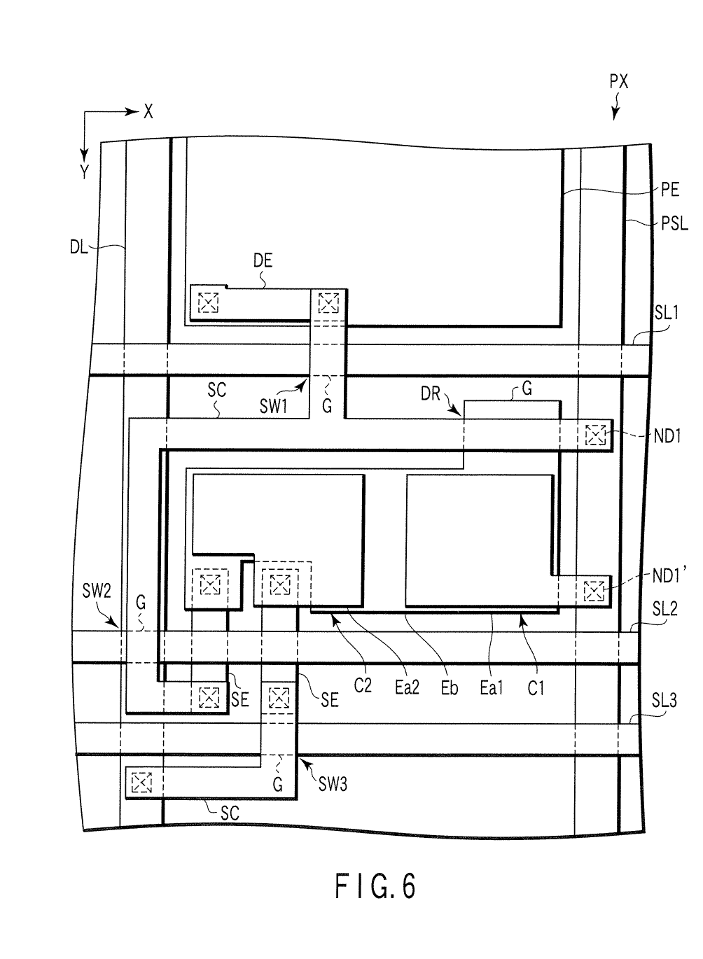

FIG. 5 is a plan view schematically showing a display according to the second embodiment of the present invention. FIG. 6 is a plan view schematically showing an example of the configuration that can be employed in a pixel included in the display shown in FIG. 6. In FIG. 6, the configuration of the pixel when viewed from the display surface's side is drawn.

The display is a bottom emission organic EL display that employs an active matrix driving method. The display has almost the same structure as that of the display according to the first embodiment except that the video signal line drive XDR outputs voltage signals as the video signals and the following structure is employed in the display panel DP.

In the display panel DP, between the undercoat layer UC and the gate insulator GI, two semiconductor layers SC is placed for one pixel PX instead of placing one semiconductor layer for one pixel PX. In addition, between the under coat layer UC and the gate insulator GI, the electrodes Ea1 and Ea2 shown in FIG. 6 are placed instead of placing the electrode Ea shown in FIG. 3. The electrodes Ea1 and Ea2 face the electrode Eb.

Between the gate insulator and the interlayer insulating film II, scan signal lines SL3 are further arranged. The scan signal lines SL3 extend in the X direction and arranged in the Y direction correspondingly with the rows of the pixels PX.

As shown in FIG. 6, in each pixel PX, one of the semiconductor layers SC intersects the scan signal line Slat a single point, intersects the scan signal line SL2 at a single point, and does not intersect the scan signal line SL3. Also, as shown in FIG. 6, the other of the semiconductor layers SC does not intersect the scan signal lines SL1 and SL2, and intersects the scan signal line SL3 at a single point.

The intersection portion of the scan signal line SL1 and the semiconductor layer SC forms the first switching transistor SW1, the intersection portion of the scan signal line SL2 and the semiconductor layer SC forms the second switching transistor SW2, and the intersection portion of the scan signal line SL3 and the semiconductor layer SC forms the third switching transistor SW3. The electrodes Ea1 and Eb and the part of the insulating film GI interposed therebetween form the capacitor C1, the electrodes Ea2 and Eb and the part of the insulating film interposed therebetween form the capacitor C2, and the intersection portion of the electrode Eb and the semiconductor layer SC forms the drive transistor DR.

Between the interlayer insulating film II and the passivation layer PS, two source electrodes SE and one drain electrode DE are placed for one pixel PX instead of placing one source electrode SE and one drain electrode DE for one pixel PX.

One of the source electrodes SE is connected to the source of the switching transistor SW2 via the contact holes formed in the interlayer insulating film II and the gate insulator GI, and further connected to the electrode Eb via the contact hole formed in the interlayer insulating film II. The other of the source electrodes SE is connected to the source of the switching transistor SW3 and the electrode Ea2 via the contact holes formed in the interlayer insulating film II and the gate insulator GI. The drain electrode DE is connected to the drain of the switching transistor SW1 via the contact holes formed in the interlayer insulating film II and the gate insulator GI. To the drain electrode DE, the pixel electrode PE is connected via the contact hole formed in the passivation layer PS.

As shown in FIG. 5, each pixel PX includes the drive transistor DR, the switching transistors SW1 to SW3, the organic EL element OLED, and the capacitors C1 and C2. In this embodiment, the drive transistor DR and the switching transistors SW1 to SW3 are p-channel thin-film transistors.

The drive transistor DR, the switching transistor SW1, and the organic EL element OLED are connected in series between the first power supply terminal ND1 and the second power supply terminal ND2 in this order. In this embodiment, the power supply terminal ND1 is a high-potential power supply terminal, and the power supply terminal ND2 is a low-potential power supply terminal.

The gate of the switching transistor SW1 is connected to the scan signal line SL1. The switching transistor SW2 is connected between the drain and gate of the drive transistor DR, and its gate is connected to the scan signal line SL2.

The capacitor C1 is connected between the gate of the drive transistor DR and the constant-potential terminal ND1′. In this embodiment, the constant-potential terminal ND1′ is connected to the power supply terminal ND1.

The switching transistor SW3 and the capacitor C2 are connected in series between the video signal line DL and the gate of the drive transistor DR in this order. The gate of the switching transistor SW3 is connected to the scan signal line SL3.

Note that the structure of the display panel DP from which the counter electrode CE and the organic layers ORG are omitted corresponds to an array substrate. Note also that the structure of the pixel PX from which the counter electrode CE and the organic layer ORG are omitted corresponds to a pixel circuit.

When an image is to be displayed on the organic EL display, the scan signal lines SL3 are sequentially energized. That is, the pixels PX are scanned or selected on a line-by-line basis. A reset operation and a write operation are sequentially executed on a pixel PX during its selection period, and a display operation is executed on a pixel PX during its non-selection period.

During the selection period over which a pixel PX is selected, the scan signal line driver YDR outputs a scan signal for opening the switching transistor SW1 as a voltage signal to the scan signal line SL1 to which the pixel PX is connected.

Subsequently, the scan signal line driver YDR outputs scan signals for closing the switching transistors SW2 and SW3 as voltage signals to the scan signal lines SL2 and SL3 to which the pixel PX is connected. In this state, the video signal line driver XDR outputs a reset signal as a voltage signal to the video signal line DL to which the pixel PX is connected, so as to set the potential of the video signal line DL at a reset potential Vᵣₛₜ. This state is maintained until no current flows between the source and drain of the drive transistor DR, so as to set the gate-to-source voltage of the drive transistor DR at its threshold voltage Vₜₕ.

Next, the scan signal line driver YDR outputs a scan signal for opening the switching transistor SW2 as a voltage signal to the scan signal line SL2 to which the pixel PX is connected. In this state, the video signal line driver XDR outputs a video signal as a voltage signal to the video signal line DL to which the pixel is connected, so as to set the potential of the video signal line DL at a write potential V_{sig} and set the gate-to-source voltage V_{gs} of the drive transistor DR at the value Vₜₕ+V_{sig}−Vᵣₛₜ that is obtained by adding the threshold voltage Vₜₕ to the difference between the write potential V_{sig} and the reset potential Vᵣₛₜ.

Thereafter, the scan signal line driver YDR outputs a scan signal for opening the switching transistor SW3 as a voltage signal to the scan signal line SL3 to which the pixel PX is connected, and then, outputs a scan signal for closing the switching transistor SW1 as a voltage signal to the scan signal line SL1 to which the pixel PX is connected. This terminates the selection period.

During the non-selection period, the switching transistor SW1 is kept closed, and the switching transistors SW2 and SW3 are kept open. In the non-selection period, a drive current I_{drv} flows through the organic EL element OLED at magnitude corresponding to the gate-to-source voltage V_{gs} of the drive transistor DR. The organic EL element OLED emits light at luminance corresponding to the magnitude of the drive current I_{drv}.

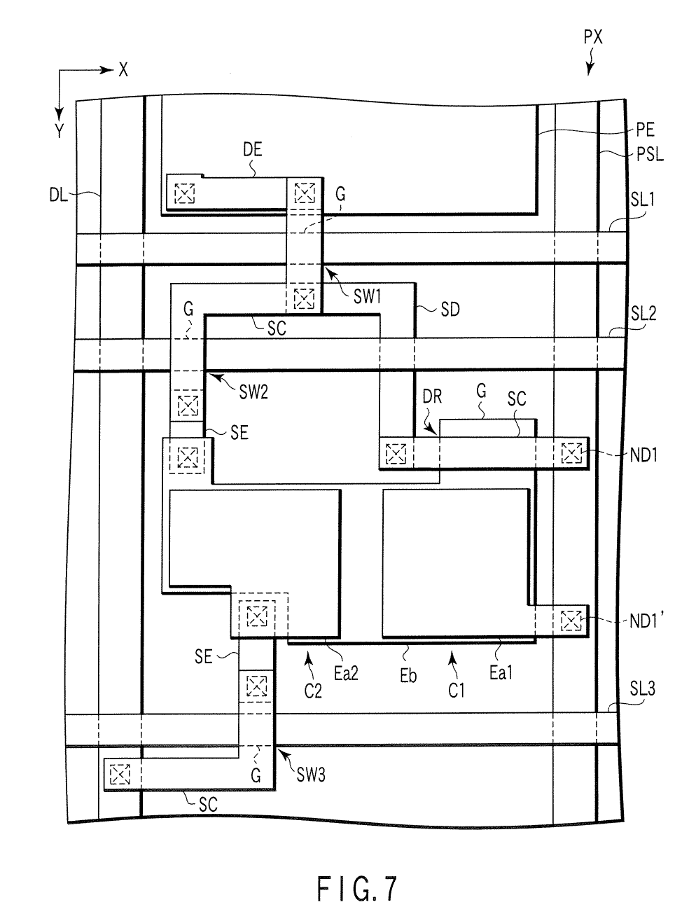

Since the configuration shown in FIG. 6 is employed in the pixel PX, the display is excellent in grayscale reproducibility. This is described with reference to FIGS. 6 and 7.

FIG. 7 is a plan view schematically showing a pixel of the display according to another comparative example. The display according to the comparative example has a structure similar to that of the display described with reference to FIGS. 5 and 6 except for the following.

As shown in FIG. 7, in the display according to the comparative example, each pixel PX includes not two semiconductor layers SC but three semiconductor layers SC. In each pixel PX, the first semiconductor layer SC intersects the scan signal line SL1 at a single point, intersects the scan signal line SL2 at a single point, and does not intersect the scan signal line SL3. Also, in each pixel PX, the second semiconductor layer SC does not intersect the scan signal lines SL1 and SL2, and intersects the scan signal line SL3 at a single point. Further, in each pixel PX, the third semiconductor layer SC does not intersect the scan signal lines SL1 to SL3, and intersects the electrode Eb at a single point. The intersection portion of the scan signal line SL1 and the semiconductor layer SC forms the switching transistor SW1, and the intersection portions of the scan signal line SL2 and the semiconductor layer SC form the switching transistors SW2 and SW3. Further, the intersection portion of the electrode Eb and the semiconductor layer SC forms the drive transistor DR.

Each electrode Eb is not located at a position between the scan signal lines SL1 and SL2 connected to the same pixel PX and between the scan signal lines SL1 and SL3 connected to the above pixel. Each electrode Eb is located at a position between the scan signal lines SL1 and SL3 connected to the same pixel PX and between the scan signal lines SL2 and SL3 connected to the above pixel PX.

Each pixel includes one electrode SD that serves as the source electrode and the drain electrode in addition to two source electrodes SE and one drain electrode DE. The electrode SD is made of the same material as that of the source electrodes SE and the drain electrode DE. The electrode SD connects two semiconductor layers SC included in the pixel PX together. Specifically, the electrode SD is connected between the drain of the drive transistor DR and the source of the switching transistor SW1.

As described above, in the pixel PX shown in FIG. 7, the electrode Eb is located at a position between the scan signal lines SL1 and SL3 connected to the same pixel PX and between the scan signal lines SL2 and SL3 connected to the above pixel PX. Thus, similar to the pixel PX shown in FIG. 4, the conductive path connecting the drain of the drive transistor DR to the source of the switching transistor SW1 must intersect the scan signal line SL2.

In the pixel PX shown in FIG. 7, as in the pixel PX shown in FIG. 4, the electrode SD is used as the conductive path. Thus, among the pixels PX, relatively large variations occur in the contact resistance between the electrode SD and the semiconductor layer SC. The contact resistance affects the time period necessary for completing the reset operation that sets the gate-to-source voltage V_{gs} of the drive transistor DR at its threshold voltage Vₜₕ. To say it in a different way, the gate-to-source voltage of the drive transistor DR to be set within a limited reset period is susceptible to the contact resistance. Thus, it is possible that the compensation for variations in the threshold voltage Vₜₕ is insufficient, and drive currents may differ even in the case where the same voltage signals are supplied. Therefore, the display employing the configuration shown in FIG. 7 in each pixel PX is prone to be insufficient in brightness evenness.

In contrast, the pixel PX shown in FIG. 6 does not include the electrode SD. Therefore, the display shown in FIG. 5 whose pixels PX employ the configuration shown in FIG. 6 never causes insufficient evenness in brightness due to the contact resistance between the electrode SD and the semiconductor layer SC. That is, according to the present embodiment, it is possible to prevent occurrence of insufficient evenness in brightness.

The configuration shown in FIG. 6 does not include the electrode SD shown in FIG. 7. In addition, the configuration shown in FIG. 6 is smaller in number of the contact holes than the configuration shown in FIG. 7. Since the area ratio of the electrode SD and the contact holes with respect to the pixel PX is relatively large, the configuration shown in FIG. 6 is advantageous in achieving high definition and high aperture ratio as compared to the configuration shown in FIG. 7.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display comprising pixels arranged in a matrix, each of the pixels comprising:
a drive transistor whose source or drain being connected to a first power supply terminal;
a display element comprising a pixel electrode, a counter electrode connected to a second power supply terminal, and an active layer interposed therebetween; and
a first switching transistor, the drive transistor and the first switching transistor being connected in series between the first power supply terminal and the pixel electrode in this order,
wherein, in each of the pixels, a semiconductor layer in which the source and drain of the drive transistor are formed and a semiconductor layer in which source and drain of the first switching transistor are formed are joined together.

2. The display according to claim 1, further comprising video signal lines arranged correspondently with columns of the pixels, each of the pixels further comprising:
a second switching transistor connected between the drain and gate of the drive transistor;
a third switching transistor, the drive transistor and the third switching transistor being connected in series between the first power supply terminal and the video signal line in this order; and
a capacitor connected between the gate of the drive transistor and a constant-potential terminal,
wherein, in each of the pixels, the semiconductor layer in which the source and drain of the drive transistor are formed, the semiconductor layer in which the source and drain of the first switching transistor are formed, a semiconductor layer in which source and drain of the second switching transistor are formed, and a semiconductor layer in which source and drain of the third switching transistor are formed are joined together.

3. The display according to claim 2, further comprising first scan signal lines arranged correspondently with rows of the pixels, and second scan signal lines arranged correspondently with the rows of the pixels,
wherein, in each of the pixels, a gate of the first switching transistor is connected to the first scan signal line, gates of the second and third switching transistors are connected to the second scan signal line, and the capacitor is located at a position between the first scan signal line to which the gate of the first switching transistor included in the pixel is connected and the second scan signal line to which the gates of the second and third switching transistors included in the pixel are connected.

4. The display according to claim 1, further comprising video signal lines arranged correspondently with columns of the pixels, each of the pixels further comprising:
a second switching transistor connected between the drain and gate of the drive transistor;
a third switching transistor;
a first capacitor connected between the gate of the drive transistor and a constant-potential terminal; and
a second capacitor, the third switching transistor and the second capacitor being connected in series between the video signal line and the gate of the drive transistor in this order,
wherein, in each of the pixels, the semiconductor layer in which the source and drain of the drive transistor are formed, the semiconductor layer in which the source and drain of the first switching transistor are formed, a semiconductor layer in which source and drain of the second switching transistor are formed, and a semiconductor layer in which source and drain of the third switching transistor are formed are joined together.

5. The display according to claim 4, further comprising first scan signal lines arranged correspondently with rows of the pixels, second scan signal lines arranged correspondently with rows of the pixels, and third scan signal lines arranged correspondently with the rows of the pixels,
wherein, in each of the pixels, gates of the first to third switching transistors are connected to the first to third scan signal lines, respectively, and the first and second capacitors are located at positions between the first and second scan signal lines to which the gates of the first and second switching transistors included in the pixel are connected, respectively, and between the first and third scan signal lines to which the gates of the first and third switching transistors included in the pixel are connected, respectively.

6. The display according to claim 1, wherein the display element is an organic EL element.

7. A display comprising pixels arranged in a matrix, video signal lines arranged correspondently with columns of the pixels, first scan signal lines arranged correspondently with rows of the pixels, and second scan signal lines arranged correspondently with the rows of the pixels, each of the pixels comprising:
a drive transistor whose source or drain is connected to a first power supply terminal;
a display element comprising a pixel electrode, a counter electrode connected to a second power supply terminal, and an active layer interposed therebetween;
a first switching transistor whose gate is connected to the first scan signal line, the drive transistor and the first switching transistor being connected in series between the first power supply terminal and the pixel electrode in this order;
a second switching transistor which is connected between the drain and gate of the drive transistor and whose gate is connected to the second scan signal line;
a third switching transistor comprising an input terminal connected to the video signal line; and
a first capacitor connected between the gate of the drive transistor and a constant-potential terminal,
wherein, in each of the pixels, the first capacitor is located at a position between the first scan signal line to which the gate of the first switching transistor included in the pixel is connected and the second scan signal line to which the gate of the second switching transistor included in the pixel is connected.

8. The display according to claim 7, wherein, in each of the pixels, the drive transistor and the third switching transistor are connected in series between the first power supply terminal and the video signal line in this order, and a gate of the third switching transistor is connected to the second scan signal line.

9. The display according to claim 7, further comprising third scan signal lines arranged correspondently with the rows of the pixels, each of the pixels further comprising a second capacitor, the third switching transistor and the second capacitor are connected in series between the video signal line and the gate of the drive transistor in this order,
wherein, in each of the pixels, the first and second capacitors are located at positions between the first and second scan signal lines to which the gates of the first and second switching transistors included in the pixel are connected, respectively, and between the first and third scan signal lines to which the gates of the first and third switching transistors included in the pixel are connected, respectively.

10. The display according to claim 7, wherein the display element is an organic EL element.

11. An array substrate comprising pixel circuits arranged in a matrix, each of the pixel circuits comprising:
a drive transistor whose source or drain being connected to a power supply terminal;
a pixel electrode; and
a first switching transistor, the drive transistor and the first switching transistor being connected in series between the power supply terminal and the pixel electrode in this order,
wherein, in each of the pixel circuits, a semiconductor layer in which the source and drain of the drive transistor are formed and a semiconductor layer in which source and drain of the first switching transistor are formed are joined together.

12. The array substrate according to claim 11, further comprising video signal lines arranged correspondently with columns of the pixel circuits, each of the pixel circuits further comprising:
a second switching transistor connected between the drain and gate of the drive transistor;
a third switching transistor, the drive transistor and the third switching transistor being connected in series between the power supply terminal and the video signal line in this order; and
a capacitor connected between the gate of the drive transistor and a constant-potential terminal,
wherein, in each of the pixel circuits, the semiconductor layer in which the source and drain of the drive transistor are formed, the semiconductor layer in which the source and drain of the first switching transistor are formed, a semiconductor layer in which source and drain of the second switching transistor are formed, and a semiconductor layer in which source and drain of the third switching transistor are formed are joined together.

13. The array substrate according to claim 11, further comprising video signal lines arranged correspondently with columns of the pixel circuits, each of the pixel circuits further comprising:
a second switching transistor connected between the drain and gate of the drive transistor;
a third switching transistor;
a first capacitor connected between the gate of the drive transistor and a constant-potential terminal; and
a second capacitor, the third switching transistor and the second capacitor being connected in series between the video signal line and the gate of the drive transistor in this order,
wherein, in each of the pixel circuits, the semiconductor layer in which the source and drain of the drive transistor are formed, the semiconductor layer in which the source and drain of the first switching transistor are formed, a semiconductor layer in which source and drain of the second switching transistor are formed, and a semiconductor layer in which source and drain of the third switching transistor are formed are joined together.

14. An array substrate comprising pixel circuits arranged in a matrix, video signal lines arranged correspondently with columns of the pixel circuits, first scan signal lines arranged correspondently with rows of the pixel circuits, and second scan signal lines arranged correspondently with the rows of the pixel circuits, each of the pixel circuits comprising:
a drive transistor whose source or drain is connected to a power supply terminal;
a pixel electrode;
a first switching transistor whose gate is connected to the first scan signal line, the drive transistor and the first switching transistor being connected in series between the power supply terminal and the pixel electrode in this order;
a second switching transistor which is connected between the drain and gate of the drive transistor and whose gate is connected to the second scan signal line;
a third switching transistor comprising an input terminal connected to the video signal line; and
a first capacitor connected between the gate of the drive transistor and a constant-potential terminal,
wherein, in each of the pixel circuits, the first capacitor is located at a position between the first scan signal line to which the gate of the first switching transistor included in the pixel circuit is connected and the second scan signal line to which the gate of the second switching transistor included in the pixel circuit is connected.

15. The array substrate according to claim 14, wherein, in each of the pixel circuits, the drive transistor and the third switching transistor are connected in series between the power supply terminal and the video signal line in this order, and a gate of the third switching transistor is connected to the second scan signal line.

16. The array substrate according to claim 14, further comprising third scan signal lines arranged correspondently with the rows of the pixel circuits, each of the pixel circuits further comprising a second capacitor, the third switching transistor and the second capacitor are connected in series between the video signal line and the gate of the drive transistor in this order,
wherein, in each of the pixel circuits, the first and second capacitors are located at positions between the first and second scan signal lines to which the gates of the first and second switching transistors included in the pixel circuit are connected, respectively, and between the first and third scan signal lines to which the gates of the first and third switching transistors included in the pixel circuit are connected, respectively.
